(19) United States
(12) Patent Application Publication
(10) Pub. No.: US 2026/0323302 A1
(43) Pub. Date: Oct. 15, 2026

(54) ELECTRONIC DEVICE AND INFORMATION SECURITY PROTECTION METHOD THEREOF

(71) Applicant: ASUSTeK COMPUTER INC., Taipei City (TW)

(72) Inventors: I-Hsien Liu, Taipei City (TW); Wei-Jhih Shen, Taipei City (TW); Chih-Kai Wang, Taipei City (TW); Chun-Liang Lu, Taipei City (TW); Jhih-Rong Syu, Taipei City (TW)

(73) Assignee: ASUSTeK COMPUTER INC., Taipei City (TW)

(21) Appl. No.: 19/643,755

(22) Filed: Apr. 9, 2026

(30) Foreign Application Priority Data
Apr. 11, 2025 (TW) 114113874

(51) Int. Cl. H04W 12/63; G06F 21/35

(52) U.S. Cl. CPC H04W 12/63; G06F 21/35

(57) ABSTRACT

Provided are an electronic device and an information security protection method thereof. The method comprises the following steps. A pairing procedure between the electronic device and an external electronic device is performed. Through a first ultra-wideband device of the electronic device, a distance between the external electronic device including a second ultra-wideband device and the electronic device is detected. The electronic device is controlled to operate in a locked state or an unlocked state according to the distance.

### CROSS-REFERENCE TO RELATED APPLICATION

This application claims the priority benefit of Taiwan application serial no. 114113874, filed on Apr. 11, 2025. The entirety of the above-mentioned patent application is hereby incorporated by reference herein and made a part of this specification.

### BACKGROUND

### Technical Field

The disclosure relates to an electronic device and an information security protection method thereof.

### Related Art

Based on personal privacy and security considerations, authorizing the use of electronic devices through identity verification has become a common operation mode. Users usually need to input the correct password or perform biometric identification to obtain the operating permission of the electronic device. Currently, the electronic device utilizes a camera to detect whether the user is in front of the device, and if the user is not detected within a certain time, the device will automatically lock. However, users may disable or cover the camera physically to prevent accidental activation and potential privacy breaches, which causes the aforementioned automatic locking function through detecting the presence status of the user to malfunction. In addition, electronic devices usually cannot lock in time when the user leaves, which result in security vulnerabilities.

On the other hand, existing technology may locate lost electronic devices through utilizing positioning technology of Global Positioning System (GPS) or Wireless Wide Area Network (WWAN). However, such positioning methods need to satisfy the conditions that the electronic device is in a powered-on state and has sufficient power to be effective. In addition, these methods usually can only provide positioning results with limited precision, making it difficult to meet the needs for higher accuracy.

### SUMMARY

The disclosure provides an information security protection method, adapted for an electronic device. The method comprises the following steps. A pairing procedure between the electronic device and an external electronic device is performed. Through a first ultra-wideband device of the electronic device, a distance between the external electronic device including a second ultra-wideband device and the electronic device is detected. The electronic device is controlled to operate in a locked state or an unlocked state according to the distance.

The disclosure provides an electronic device, which comprises a first ultra-wideband device, a storage device, and a processor. The processor is coupled to the first ultra-wideband device and the storage device. The storage device records multiple commands, and the processor is configured to execute the commands to perform the following operations. A pairing process between the electronic device and an external electronic device is performed. Through the first ultra-wideband device, a distance between the external electronic device including a second ultra-wideband device and the electronic device is detected. The electronic device is controlled to operate in a locked state or an unlocked state according to the distance.

Based on the above, in the embodiments of the disclosure, the first ultra-wideband device of the electronic device and the second ultra-wideband device of the external electronic device are utilized to measure the distance between the external electronic device and the electronic device. Therefore, the electronic device is locked or unlocked according to the distance between the external electronic device and the electronic device. Based on above, the operation not only can effectively prevent unauthorized personnel from operating the electronic device, but can also enhance the immediacy of unlocking and locking the electronic device.

### BRIEF DESCRIPTION OF THE DRAWINGS

FIG. 1 is a block diagram of an information security protection system according to an embodiment of the disclosure.

FIG. 2 is a flowchart of an information security protection method according to an embodiment of the disclosure.

FIG. 3 is a flowchart of the information security protection method according to an embodiment of the disclosure.

FIGS. 4A and 4B are scenario diagrams according to embodiments of the disclosure.

FIG. 5 is a flowchart of the information security protection method according to an embodiment of the disclosure.

FIG. 6 is a block diagram of the information security protection system according to an embodiment of the disclosure.

FIG. 7 is a flowchart of the information security protection method according to an embodiment of the disclosure.

### DESCRIPTION OF THE EMBODIMENTS

The following detailed description of some embodiments of this disclosure will be made with reference to the accompanying drawings. When the same reference numerals appear in different drawings, the reference numerals will be regarded as the same or similar components. The embodiments are merely a part of this disclosure and do not reveal all possible implementations. More precisely, the embodiments are merely examples of the devices and methods in the appended claims of this disclosure.

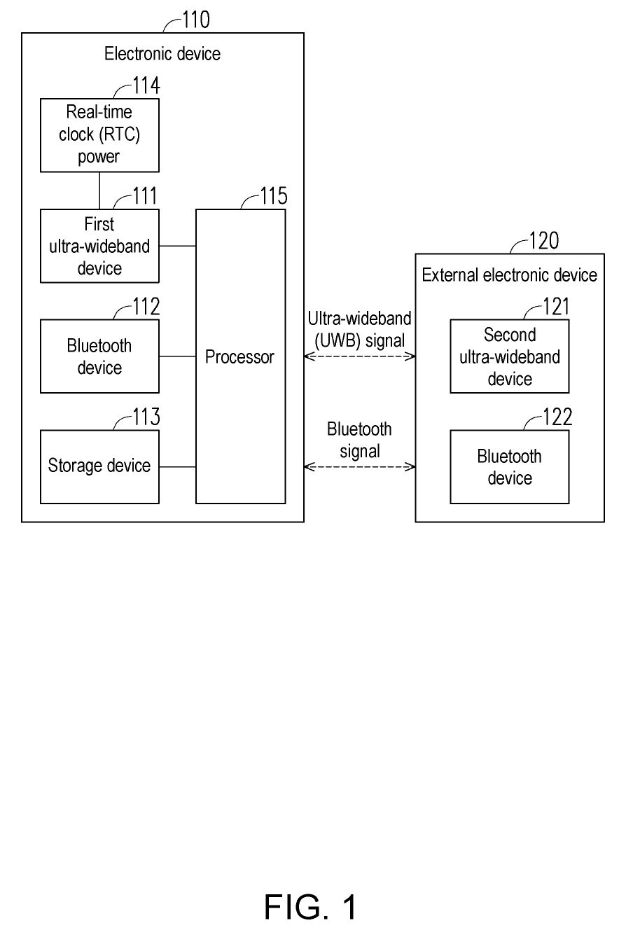

Referring to FIG. 1, in an embodiment of the disclosure, an information security protection system comprises an electronic device 110 and an external electronic device 120. The electronic device 110 is a laptop computer, tablet computer, smartphone, or gaming console, or other personal electronic device, but the disclosure is not limited thereto. The external electronic device 120 is a wearable electronic device, smart watch, smartphone, or an electronic tag with ultra-wideband (Ultra-Wideband, UWB) communication function and Bluetooth communication function, but the disclosure is not limited thereto.

In an embodiment of the disclosure, the external electronic device 120 serves as an electronic key for locking or unlocking the electronic device 110, configured to verify user permissions and control the electronic device 110 to switch between a locked state and an unlocked state. When the external electronic device 120 is sufficiently close to the electronic device 110, the electronic device 110 switches from the locked state to the unlocked state or remain in the unlocked state. When the external electronic device 120 moves away from the electronic device 110, the electronic device 110 switches from the unlocked state to the locked state or remain in the locked state.

In an embodiment of the disclosure, the electronic device 110 and the external electronic device 120 utilizes ultra-wideband communication technology to confirm the distance or relative position relationship between the electronic device 110 and the external electronic device 120, so as to lock or unlock the electronic device 110 based on the distance or relative position relationship between the electronic device 110 and the external electronic device 120.

In some embodiments, the electronic device 110 comprises a first ultra-wideband device 111, a Bluetooth device 112, a storage device 113, a real-time clock (RTC) power 114, and a processor 115.

The first ultra-wideband device 111, also known as an ultra-wideband sensor, has an ultra-wideband antenna and a transceiver circuit. The first ultra-wideband device 111 is a high-precision sensing device based on ultra-wideband technology, which operates in a range of 3.1 GHz to 10.6 GHz, designed according to IEEE 802.15.4z standard. Compared with conventional narrowband radio, UWB technology has a wider spectrum range, requires significantly low energy for signal transmission, and exhibits excellent low power consumption characteristics. The first ultra-wideband device 111 transmits and receives high-frequency pulse signals through the ultra-wideband antenna, and the transceiver circuit performs signal processing and data transmission, which enables the first ultra-wideband device 111 to precisely measure the distance between target objects.

The Bluetooth device 112 is a wireless module that integrates Bluetooth communication protocol, used for short-range wireless data transmission. The Bluetooth device 112 comprises a Bluetooth chip, an RF circuit, and an antenna, and connects to the main control device through standard interfaces (such as UART, SPI, I2C). The Bluetooth device 112 supports various Bluetooth versions, including, for example, economical Bluetooth 4.0/4.2 and power-optimized Bluetooth 5.0/5.3, and the disclosure is not limited thereto.

In an embodiment, the storage device 113 is configured to store data and software modules (such as operating system, applications, drivers) for the processor 115 to access, which can be any type of fixed or removable random access memory (RAM), read-only memory (ROM), flash memory, hard disk, or the combinations thereof.

The RTC power 114 provides dedicated power for the electronic device 110, ensuring that even when the main power of the electronic device 110 is turned off, the RTC power 114 can still operate normally. The RTC power 114 is typically provided by a backup battery (such as a button cell) or supercapacitor that provides stable low-power electricity to support continuous time tracking and timing functions. In the embodiment of the disclosure, the RTC power 114 is connected to the first ultra-wideband device 111. The RTC power 114 of the electronic device 110 provides power to the first ultra-wideband device 111 to ensure that the first ultra-wideband device 111 can continue to operate even when the main power is turned off. Even when the electronic device 110 is powered off, the first ultra-wideband device 111 can still operate.

The processor 115 is coupled to the first ultra-wideband device 111, the Bluetooth device 112, and the storage device 113. The processor 115 is, for example, a central processing unit (CPU), an application processor (AP), or other programmable general-purpose or special-purpose microprocessors, a digital signal processor (DSP), an image signal processor (ISP), a graphics processing unit (GPU), or other similar devices, integrated circuits, and combinations thereof. The processor 115 accesses and execute commands recorded in the storage device 113 to implement the information security protection method in the embodiments of the disclosure.

In some embodiments, the external electronic device 120 comprises a second ultra-wideband device 121 and a Bluetooth device 122. The function and hardware of the second ultra-wideband device 121 are similar to the first ultra-wideband device 111, and the function and hardware of the Bluetooth device 122 are similar to the Bluetooth device 112, so details will not be repeated here.

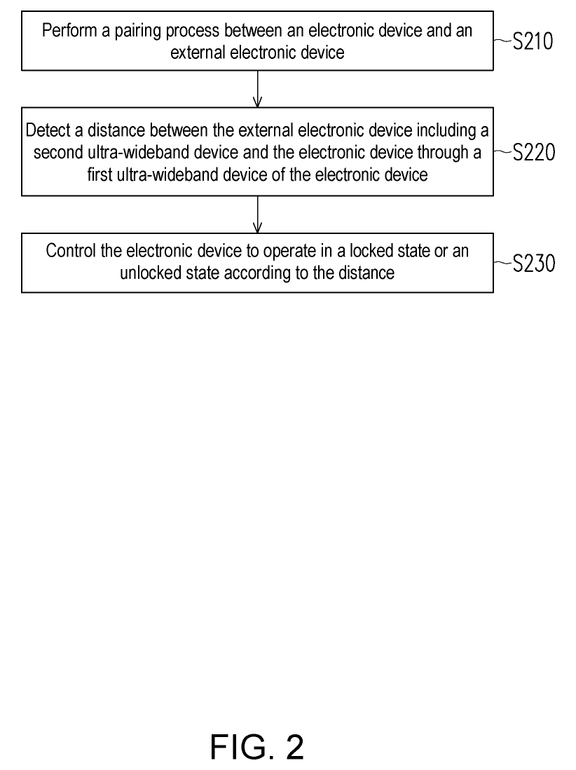

Referring to both FIGS. 1 and 2, the method of this embodiment is adapted for the information security protection system. The following describes the detailed steps of the information security protection method of this embodiment in conjunction with various components of the electronic device 110 and the external electronic device 120.

In Step S210, a pairing process is performed between the electronic device 110 and the external electronic device 120. The electronic device 110 uses the Bluetooth device 112 to perform the pairing process with the Bluetooth device 122 of the external electronic device 120. In some embodiments, the pairing process comprises exchanging pairing data through the first ultra-wideband device 111 and the second ultra-wideband device 121 to establish a unique identification relationship. During the pairing process, the electronic device 110 and the external electronic device 120 verifies each other's identity and generate encryption keys. After completing the pairing, a trusted relationship is formed between the electronic device 110 and the external electronic device 120, and subsequent Bluetooth connections can be established directly without re-verification. Overall, the electronic device 110 and the external electronic device 120 identifies each other through the pairing process.

In Step S220, a distance between the external electronic device 120 including the second ultra-wideband device 121 and the electronic device 110 is detected through the first ultra-wideband device 111 of the electronic device 110. In some embodiments, one of the first ultra-wideband device 111 and the second ultra-wideband device 121 emits ultra-wideband pulse signals and receive response signals from the other one of the first ultra-wideband device 111 and the second ultra-wideband device 121. Based on Time of Flight (ToF) method to calculate the round-trip time of signals, the electronic device 110 or the external electronic device 120 obtains the distance between the two devices. This distance measurement has high precision characteristics, suitable for precise positioning and distance determination requirements. UWB signals are formed by significantly short pulses (nanosecond level) with high time resolution, thus enabling the measurement of significantly short propagation time.

In Step S230, the processor 115 controls the electronic device 110 to operate in a locked state or an unlocked state according to the distance. In some embodiments, when the distance is less than a preset secure range, the processor 115 verifies the external electronic device 120 as an authorized device, and switches the electronic device 110 to the unlocked state, allowing the user to access device functions. Conversely, if the distance exceeds the secure range or the external electronic device 120 has not completed the pairing process, the processor 115 controls the electronic device 110 to switch to the locked state, prohibiting unauthorized operations. Based on above, due to the high precision distance measurement and real-time response capability of ultra-wideband technology, the operation security and immediacy of locking of the electronic device 110 can be ensured. More specifically, since the electronic device 110 continuously and with high frequency obtains the distance between the external electronic device 120 and the electronic device 110, the electronic device can quickly react to the approach and departure of the user to switch between the locked state and the unlocked state.

In some embodiments, when one of the first ultra-wideband device 111 and the second ultra-wideband device 121 has multiple ultra-wideband antennas, the first ultra-wideband device 111 or the second ultra-wideband device 121 obtains the relative position relationship between the electronic device 110 and the external electronic device 120 according to Angle of Arrival (AOA) technology. Based on above, the processor 115 controls the electronic device 110 to operate in the locked state or the unlocked state according to the relative position relationship and distance between the electronic device 110 and the external electronic device 120. In some embodiments, when the external electronic device 120 is located on the display side of the electronic device 110 and close enough, the electronic device 110 is controlled to operate in the unlocked state. When the external electronic device 120 is located on the non-display side or back side of the electronic device 110, the electronic device 110 is controlled to operate in the locked state.

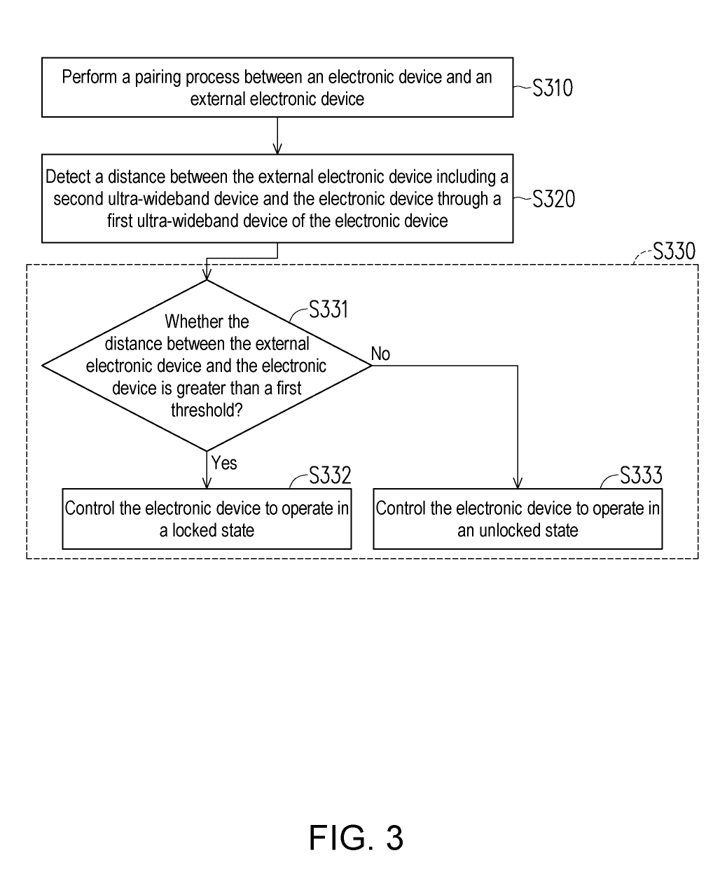

Referring to both FIGS. 1 and 3, the method of this embodiment is adapted for the information security protection system. The following describes the detailed steps of the information security protection method of this embodiment in conjunction with various components of the electronic device 110 and the external electronic device 120.

In Step S310, a pairing process is performed between the electronic device 110 and the external electronic device 120. In Step S320, the distance between the external electronic device 120 including the second ultra-wideband device 121 and the electronic device 110 is detected through the first ultra-wideband device 111 of the electronic device 110.

In Step S330, the processor 115 controls the electronic device 110 to operate in a locked state or an unlocked state according to the distance. In some embodiments, Step S330 is implemented as Steps S331 to S333.

In Step S331, the processor 115 determines whether the distance between the external electronic device 120 and the electronic device 110 is greater than a first threshold. The first threshold is designed according to actual applications, but the disclosure is not limited thereto.

When the distance is greater than the first threshold (Step S331 determines yes), in Step S332, the processor 115 controls the electronic device 110 to operate in the locked state. In some embodiments, when the electronic device 110 operates in the locked state, the electronic device 110 logs out of the operating system and display a locked screen. The locked screen, for example, is a user login screen, but the disclosure is not limited thereto.

When the distance is not greater than the first threshold (Step S331 determines no), in Step S333, the processor 115 controls the electronic device 110 to operate in the unlocked state. In some embodiments, when the distance is not greater than the first threshold, the operating system of the electronic device 110 is logged in, allowing the user to use the electronic device 110 normally. Furthermore, based on the completion of the pairing process, the electronic device 110 confirms that the external electronic device 120 is an authorized device, and stores and records the user account or device identification information corresponding to the external electronic device 120, so as to log in to the operating system of the electronic device 110 based on the authorized user account or device identification information.

In some embodiments, based on the high-frequency distance measuring capability of ultra-wideband technology, the processor 115 controls the electronic device 110 to operate in the locked state after determining that n consecutive distances are greater than the first threshold. Accordingly, the operation avoids other factors such as noise interference affecting the distance measurement results and erroneously controlling the electronic device 110 to enter the locked state.

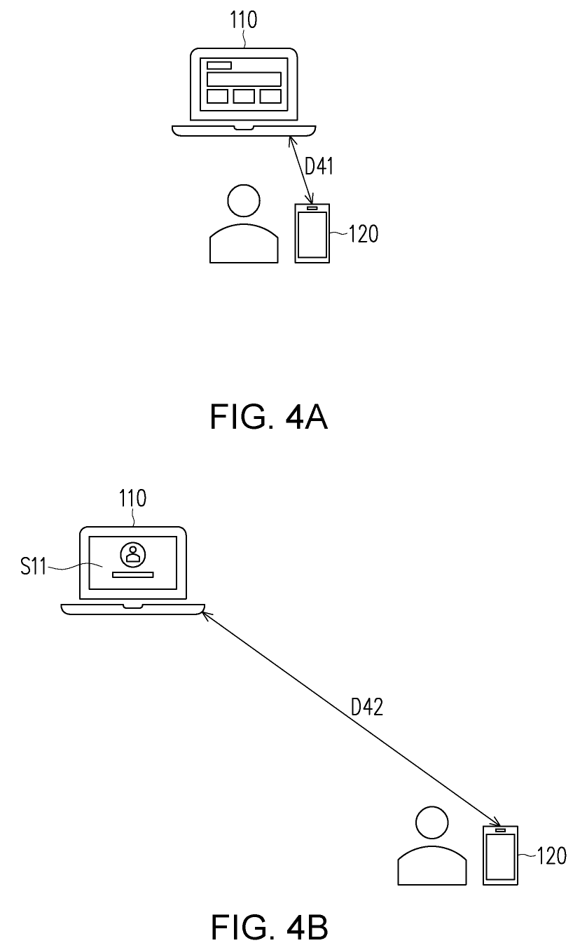

For example, referring to FIG. 4A, when a distance D41 between the external electronic device 120 (for example, a mobile phone) and the electronic device 110 (for example, a laptop) is less than the first threshold, the electronic device 110 operates in the unlocked state and the operating system is in a logged-in state. Referring to FIG. 4B, the user carries the external electronic device 120 away from the electronic device 110. When a distance D42 between the external electronic device 120 and the electronic device 110 is greater than the first threshold, the electronic device 110 operates in the locked state and the operating system is in a logged-out state. When operating in the locked state, the electronic device 110 displays a user login screen S11.

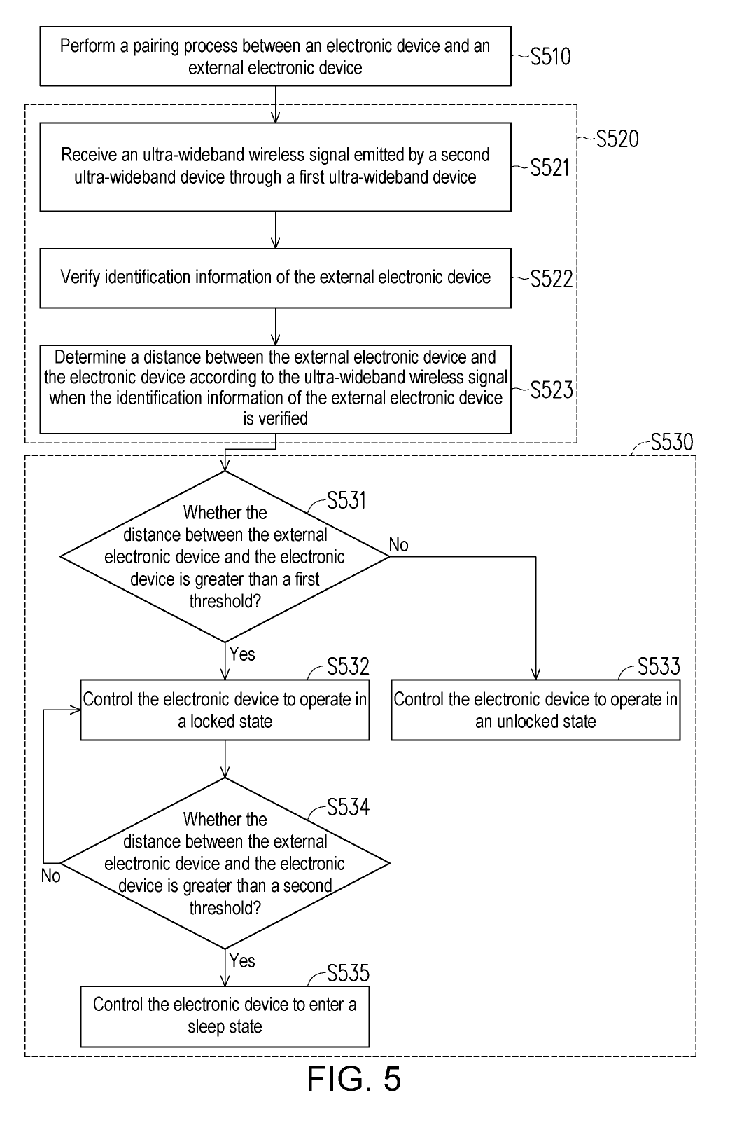

Referring to both FIGS. 1 and 5, the method of this embodiment is adapted for the information security protection system. The following describes the detailed steps of the information security protection method of this embodiment in conjunction with various components of the electronic device 110 and the external electronic device 120.

In Step S510, a pairing process is performed between the electronic device 110 and the external electronic device 120. In Step S520, the distance between the external electronic device 120 including the second ultra-wideband device 121 and the electronic device 110 is detected through the first ultra-wideband device 111 of the electronic device 110. In some embodiments, Step S520 is implemented as Steps S521 to S523.

In Step S521, an ultra-wideband wireless signal emitted by the second ultra-wideband device 121 is received through the first ultra-wideband device 111. The ultra-wideband wireless signal carries the identification information of the external electronic device 120. In some embodiments, the ultra-wideband wireless signal received by the first ultra-wideband device 111 comprises an encrypted identification code and timestamp sent by the second ultra-wideband device 121. After the first ultra-wideband device 111 decodes the ultra-wideband wireless signal, the identification information and related parameters is extracted for subsequent verification and distance measurement calculations. In an embodiment, the identification information is a user account or device identification code.

In Step S522, the identification information of the external electronic device 120 is verified. In some embodiments, the electronic device 110 receives and records preset identification information of the external electronic device 120. The identification information of the external electronic device 120 is verified based on the preset identification information. During the verification process, the processor 115 of the electronic device 110 compares the identification information received with a pre-registered database stored internally. If a match is found, then the external electronic device 120 is confirmed as an authorized device. The verification process uses encryption operations on keys to ensure the security of the verification process.

In Step S523, when the identification information of the external electronic device 120 is verified, the processor 115 of the electronic device 110 determines the distance between the external electronic device 120 and the electronic device 110 according to the ultra-wideband wireless signal. The calculation of the distance is based on the Time of Flight (ToF) of the ultra-wideband wireless signal, which is the time required for the signal to transmit from the electronic device 110 to the external electronic device 120 and return. In some embodiments, the processor 115 further continuously receives and analyzes multiple distance measurement results, applying filtering technology to reduce the impact of environmental interference on the distance measurement data, ensuring the reliability of the final distance measurement results.

In Step S530, the processor 115 controls the electronic device 110 to operate in the locked state or the unlocked state according to the distance. In some embodiments, Step S330 is implemented as Steps S531 to S535.

In Step S531, the processor 115 determines whether the distance between the external electronic device 120 and the electronic device 110 is greater than the first threshold. In Step S533, when the distance is not greater than the first threshold, the processor 115 controls the electronic device to operate in the unlocked state. In Step S532, when the distance is greater than the first threshold, the processor 115 controls the electronic device to operate in the locked state.

It is worth mentioning that, when the distance is greater than the first threshold, in Step S534, the processor 115 determines whether the distance between the external electronic device 120 and the electronic device 110 is greater than a second threshold. When the distance is greater than the second threshold, in Step S535, the processor 115 controls the electronic device 110 to enter a sleep state. The second threshold is greater than the first threshold. That is to say, when the user leaves and the distance between the external electronic device 120 and the electronic device 110 is greater than the second threshold, the electronic device 110 is directly controlled to enter a power-saving sleep state, thereby achieving the purpose of power saving. In addition, when the user returns and the distance between the external electronic device 120 and the electronic device 110 is not greater than the second threshold, the electronic device 110 operating in the sleep state is awakened but remained in the locked state.

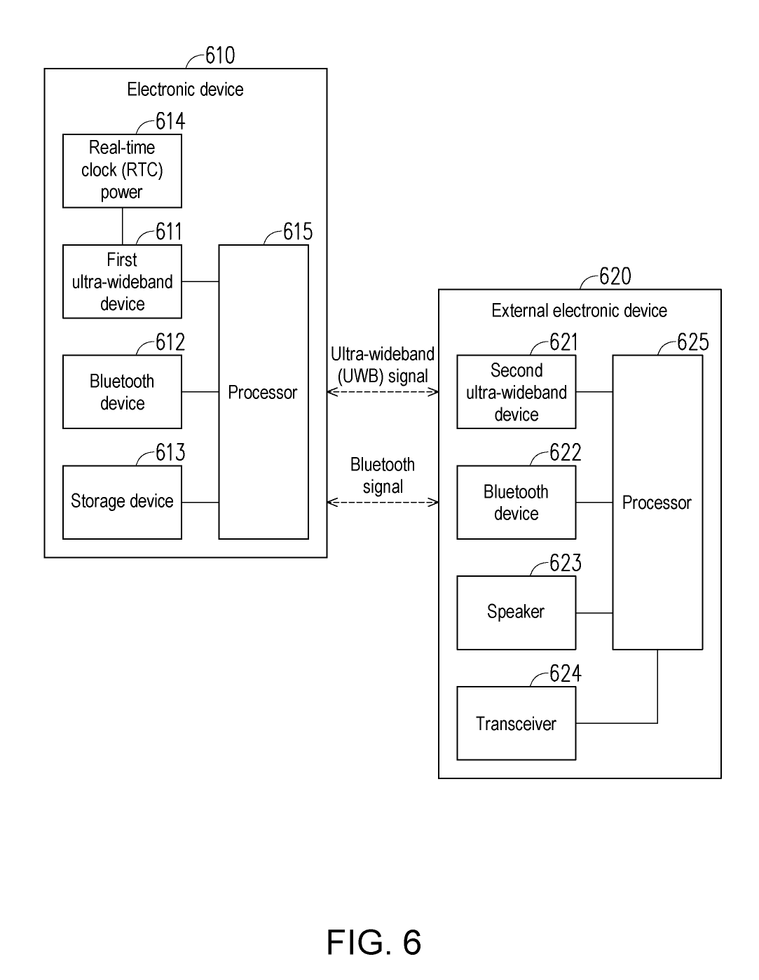

FIG. 6 is a block diagram of an information security protection system according to an embodiment of the disclosure. The information security protection system comprises an electronic device 610 and an external electronic device 620. The electronic device 610 comprises a first ultra-wideband device 611, a Bluetooth device 612, a storage device 613, a real-time clock (RTC) power 614, and a processor 615, and the above components are similar to the corresponding components shown in FIG. 1, so details will not be repeated here.

It should be noted that the external electronic device 620 comprises a second ultra-wideband device 621, a Bluetooth device 622, a speaker 623, a transceiver 624, and a processor 625. The processor 625 is coupled to the second ultra-wideband device 621, the Bluetooth device 622, the speaker 623, and the transceiver 624. The speaker 623 is configured to play sound. The transceiver 624 is configured to be connected to a network to transmit and receive data. In some embodiments, when the electronic device 610 is lost, the user searches for the electronic device 610 through the external electronic device 620.

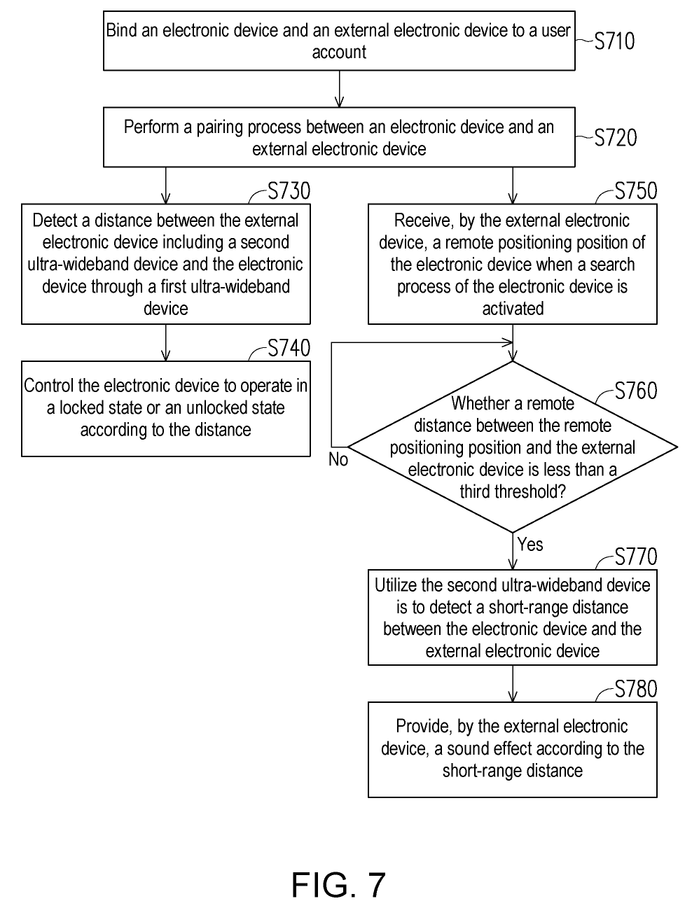

Referring to both FIGS. 6 and 7, the method of this embodiment is adapted for the information security protection system. The following describes the detailed steps of the information security protection method of this embodiment in conjunction with various components of the electronic device 610 and the external electronic device 620.

In Step S710, the electronic device 610 and the external electronic device 620 are bound to a user account. The binding process is completed through a server verification system, where the unique identifiers (such as device serial numbers or hardware addresses) of the electronic device 610 and the external electronic device 620 are associated with the user account. The binding process requires the user to provide authentication information (such as password or multi-factor authentication) to ensure that only authorized accounts have control. After the binding is completed, the user account can uniformly manage the devices.

In Step S720, a pairing process is performed between the electronic device 610 and the external electronic device 620. In Step S730, a distance between the external electronic device 620 including the second ultra-wideband device 621 and the electronic device 610 is detected through the first ultra-wideband device 611 of the electronic device 610. In Step S740, the processor 115 controls the electronic device 110 to operate in a locked state or an unlocked state according to the distance. For implementation details of Step S720 to Step S740, reference is made to the foregoing embodiments, so details will not be repeated here.

It should be noted that, in Step S750, when the search process of the electronic device 610 is activated, the external electronic device 620 receives a remote positioning position of the electronic device 610. In some embodiments, through the built-in GPS module of the electronic device 610, the electronic device 610 obtains the latitude and longitude of the current remote positioning position and encrypt and transmit the positioning data to the external electronic device 620. Alternatively, in some embodiments, through other wide area communication modules built into the electronic device 610, the electronic device 610 obtains the current remote positioning position and encrypt and transmit the positioning data to the external electronic device 620. The external electronic device 620 presents the position of the electronic device 610 on a user interface in the form of a map or direction indication, making it convenient for the user to quickly find the electronic device 610.

In Step S760, the external electronic device 620 determines whether a remote distance between the remote positioning position and the external electronic device 620 is less than a third threshold. Furthermore, based on the remote positioning position, the user carries the external electronic device 620 to move toward a direction closer to the remote positioning position. During the search process of the electronic device 610, the external electronic device 620 continuously determines whether the remote distance between the remote positioning position and the current position of the external electronic device 620 is less than the third threshold.

In Step S770, when the remote distance is less than the third threshold, the second ultra-wideband device 621 is utilized to detect a short-range distance between the electronic device 610 and the external electronic device 620. When the remote distance is less than the third threshold, it means that the user is already close enough to the electronic device 610 and uses ultra-wideband ranging with smaller but more precise ranging range to continue finding the electronic device 610. Therefore, when the remote distance is less than the third threshold, the external electronic device 620 utilizes the second ultra-wideband device 621 to detect the short-range distance with the electronic device 610.

In Step S780, the external electronic device 620 provides a sound effect through the speaker 623 according to the short-range distance. In some embodiments, a sound effect characteristic of the sound effect changes in response to changes in the short-range distance. The sound effect characteristic, for example, is sound frequency (for example, high pitch or low pitch) or sound emission frequency (for example, slow beeps or fast beeps). For instance, when the external electronic device 620 senses approaching the electronic device 610, the speaker 623 of the external electronic device 620 emits a high-frequency sound effect. When the external electronic device 620 senses moving away from the electronic device 610, the speaker 623 of the external electronic device 620 emits a low-frequency sound effect, so as to precisely determine the position of the electronic device. Through the application of ultra-wideband positioning, the operation compensates for the inaccuracy issues of GPS positioning or other wide area network positioning.

In summary, in the embodiments of the disclosure, the first ultra-wideband device of the electronic device and the second ultra-wideband device of the external electronic device is utilized to measure the distance between the external electronic device and the electronic device. Therefore, the electronic device is locked or unlocked according to the distance between the external electronic device and the electronic device. Based on above, the operation not only can effectively prevent unauthorized personnel from operating the electronic device, but can also enhance the immediacy of unlocking and locking the electronic device. Furthermore, with the assistance of ultra-wideband technology for lost device search, lost devices can be found quickly and precisely.

Although the disclosure has been disclosed in the foregoing embodiments, the embodiments are not intended to limit the disclosure. Persons with ordinary knowledge in the relevant technical field may make some changes and modifications without departing from the spirit and scope of the disclosure. Therefore, the protection scope of the disclosure should be defined by the appended claims and the equivalent scope thereof.

What is claimed is:

1. An information security protection method, comprising:
performing a pairing process between an electronic device and an external electronic device;
detecting a distance between the external electronic device comprising a second ultra-wideband device and the electronic device through a first ultra-wideband device of the electronic device; and
controlling the electronic device to operate in a locked state or an unlocked state according to the distance.

2. The information security protection method as claimed in claim 1, wherein the step of controlling the electronic device to operate in the locked state or the unlocked state according to the distance further comprises:
controlling the electronic device to operate in the locked state in response to the distance being greater than a first threshold; and
controlling the electronic device to operate in the unlocked state in response to the distance not being greater than the first threshold.

3. The information security protection method as claimed in claim 2, wherein the step of controlling the electronic device to operate in the unlocked state in response to the distance not being greater than the first threshold further comprises:
logging in an operating system of the electronic device in response to the distance not being greater than the first threshold.

4. The information security protection method as claimed in claim 2, wherein the step of controlling the electronic device to operate in the locked state in response to the distance being greater than the first threshold further comprises:
controlling the electronic device to enter a sleep state in response to the distance being greater than a second threshold, wherein the second threshold is greater than the first threshold.

5. The information security protection method as claimed in claim 1, further comprising:
providing power, by a real-time clock (RTC) power of the electronic device, to the first ultra-wideband device.

6. The information security protection method as claimed in claim 1, wherein the step of detecting the distance between the external electronic device comprising the second ultra-wideband device and the electronic device through the first ultra-wideband device further comprises:
receiving, by the second ultra-wideband device, an ultra-wideband wireless signal emitted through the first ultra-wideband device, wherein the ultra-wideband wireless signal carries identification information of the external electronic device;
verifying the identification information of the external electronic device; and
determining the distance between the external electronic device and the electronic device according to the ultra-wideband wireless signal in response to the identification information of the external electronic device being verified.

7. The information security protection method as claimed in claim 6, wherein the step of performing the pairing process between the electronic device and the external electronic device further comprises:
receiving and recording preset identification information of the external electronic device, wherein the identification information of the external electronic device is verified based on the preset identification information.

8. The information security protection method as claimed in claim 1, wherein after the step of performing the pairing process between the electronic device and the external electronic device, the method further comprising:
utilizing the second ultra-wideband device to detect a short-range distance between the electronic device and the external electronic device; and
providing a sound effect, by the external electronic device, according to the short-range distance.

9. The information security protection method as claimed in claim 8, wherein a sound effect characteristic of the sound effect changes in response to changes in the short-range distance.

10. The information security protection method as claimed in claim 8, wherein the step of utilizing the second ultra-wideband device to detect the short-range distance between the electronic device and the external electronic device further comprises:
binding the electronic device and the external electronic device to a user account;
receiving, by the external electronic device, a remote positioning position of the electronic device in response to a search process of the electronic device being activated;
determining, by the external electronic device, whether a remote distance between the remote positioning position and the external electronic device is less than a third threshold; and
utilizing the second ultra-wideband device to detect the short-range distance between the electronic device and the external electronic device in response to the remote distance being less than the third threshold.

11. An electronic device, comprising:
a first ultra-wideband device having an ultra-wideband antenna;
a storage device recording a plurality of commands; and
a processor connected to the first ultra-wideband device and the storage device, and configured to execute the commands to:
perform a pairing process between the electronic device and an external electronic device;
detect a distance between the external electronic device comprising a second ultra-wideband device and the electronic device through the first ultra-wideband device; and
control the electronic device to operate in a locked state or an unlocked state according to the distance.
